(19) United States
(12) Patent Application Publication
(10) Pub. No.: US 2017/0096297 A1
(43) Pub. Date: Apr. 6, 2017

(54) SYSTEMS AND METHODS FOR SEPARATING LIQUIDS FROM SOLIDS THROUGH COMPACTION

(71) Applicant: SIMPLY RIGHT, INC., Ogden, UT (US)

(72) Inventor: Bryan W. Call, Idaho Falls, ID (US)

(73) Assignee: SIMPLY RIGHT, INC., Ogden, UT (US)

(21) Appl. No.: 15/285,668

(22) Filed: Oct. 5, 2016

Related U.S. Application Data
(60) Provisional application No. 62/237,438, filed on Oct. 5, 2015.

(51) Int. Cl. B65F 1/14; B65F 1/12; B65F 1/00; B30B 9/04; B30B 15/06

(52) U.S. Cl. CPC B65F 1/1405; B30B 9/04; B30B 15/065; B65F 1/002; B65F 1/12

(57) ABSTRACT

A compaction system includes a compaction cavity having an inlet opening sized to receive a bag containing liquids and solids, and a compaction ram movable within the compaction cavity to compact the bag. At least one of the compaction cavity and the compaction ram includes at least one piercing member arranged and configured to puncture the bag to permit release of the liquids from the bag. The released liquids are collected with a liquid collection member.

### RELATED APPLICATION

This application claims priority to U.S. Provisional Patent Application No. 62/237,438, filed on 5 Oct. 2015, and entitled SYSTEMS AND METHODS FOR SEPARATING LIQUIDS FROM SOLIDS THROUGH COMPACTION, which application is incorporated herein in its entirety by this reference.

### TECHNICAL FIELD

The present disclosure generally relates to compaction devices, and more particularly relates to trash compaction devices.

### BACKGROUND

Residential and commercial trash is generally voluminous and, which may cause challenges in being able to transport large amounts of the trash efficiently and economically. Trash compactors have been employed for decades to assist in reducing the volume of the trash, particularly prior to transport, thereby permitting greater amounts of trash to be transported by a single vehicle. Some sources of trash include relatively large amounts of liquid in combination with solid products. For example, movie theatres collect trash that includes large popcorn and drink containers in addition to large amounts of liquids resulting from leftover ice and unused drinks from moviegoers. The liquid and solid trash is collected in liquid-tight plastic bags to prevent undesired leaking of the liquids during transport to a trash collection facility.

The liquids in these bags of trash impose some challenges associated with compacting the trash. For example, the liquids may flow out of the trash compacter onto the ground surrounding the trash compactor during compaction of the trash. The leaked liquids may be sticky, attract flies and other bugs, and create and have an undesirable smell. Further, when using at least some types of trash compactors, the liquids present in the plastic bags may inhibit maximized compaction of the solids.

Opportunities exist for improving trash compactors, particularly when compacting trash that includes liquids and solids.

### SUMMARY

The present disclosure relates to a compaction system and related methods of compacting bags that include liquid and solid refuse and collecting the liquids from the compacted bags. In one embodiment, a compaction system includes a compaction cavity having an inlet opening sized to receive a bag containing liquids and solids, and a compaction ram movable within the compaction cavity to compact the bag. Typically, at least one of the compaction cavity and the compaction ram includes at least one piercing member arranged and configured to puncture the bag to permit release of the liquids from the bag.

A liquid collection member may be arranged to collect the liquids that are released from the bag. The liquid collection member may include a collection pan positioned below the compaction cavity. The compaction cavity may include a bottom wall upon which the liquids collect, and the bottom wall is slanted toward the liquid collection member to provide gravity flow of the liquids. The compaction ram may include a face plate arranged to contact the bag, and the at least one piercing member may be positioned on the face plate. The at least one piercing member may include at least one first piercing member positioned on a wall of the compaction cavity, and at least one second piercing member positioned on the compaction ram. The at least one piercing member may include a plurality of piercing members. The compaction system may further include a liquid collection channel positioned along a bottom side of the compaction cavity and terminating at the liquid collection member.

Another embodiment is directed to a compaction system that includes a compaction cavity, inlet and outlet openings, first and second piercing members, a compaction ram, and a liquid collection member. The compaction cavity includes a plurality of walls including a bottom wall. The inlet opening is sized to receive a bag containing liquids and solids. The outlet opening provides an outlet for compacted bags. The first piercing member is positioned on at least one of the plurality of walls; of the compaction cavity. The compaction ram is movable within the compaction cavity to compact the bag. The compaction ram includes a face plate arranged to contact the bag. The face plate includes the second piercing member. The liquid collection member is positioned along a bottom side of the compaction cavity. At least one of the first piercing member and the second piercing member are configured to pierce the bag to permit release of the liquids from the bag onto the bottom wall. The liquids released from the bag are collected by the liquid collection member.

The liquid collection member may include a collection pan that is arranged in parallel with the bottom side of the compaction cavity. The compaction cavity may include a plurality of first piercing members positioned on the bottom wall. The compaction ram may include a plurality of second piercing members positioned on the face plate. The compaction cavity may include a contoured or elevated portion. The compaction system may include a pump operable to remove liquids collected in the liquid collection member.

A further embodiment relates to a method of collecting liquids from bagged refuse. The refuse includes solids and liquids. The method includes providing a compaction system that includes a compaction cavity, a compaction ram, a liquid collection member, and a plurality of bag piercing members positioned in the compaction cavity and positioned on the compaction ram. The compaction cavity includes an inlet opening and an outlet opening. The method also includes the steps of receiving at least one bag through in the inlet opening into the compaction cavity, the at least one bag containing liquids and solids, moving the compaction ram within the compaction cavity to compact the at least one bag, puncturing the at least one bag with the plurality of bag piercing members to release the liquids from the bag, and collecting the liquids with a liquid collection member.

The compaction cavity and the compaction ram may each include at least one of the plurality of bag piercing members, and moving the compaction ram to compact the at least one bag may cause the plurality of bag piercing members to puncture the at least one bag. The method may include advancing the at least one bag out of the outlet opening after the bag is compacted and punctured. The compaction cavity may include top, bottom and opposing side surfaces, and at least some of the plurality of bag piercing members are positioned on the bottom surface. The method may include collecting the liquid along a bottom side of the compaction cavity. The method may include orienting the compaction cavity at an angle relative to a horizontal plane and flowing the liquids along a bottom surface of the compaction cavity by gravity forces.

### BRIEF DESCRIPTION OF THE DRAWINGS

The accompanying drawings illustrate certain embodiments discussed below and are a part of the specification.

FIG. 1 is a side view of an example compaction system in accordance with the present disclosure.

FIG. 2 is a top view of the compaction system shown in FIG. 1.

FIG. 3 is a cross-sectional view of the compaction system shown in FIG. 2 taken along cross section indicators 3-3.

FIG. 4 is a cross-sectional view of the compaction system shown in the FIG. 2 in operation compacting a trash bag.

FIG. 5 is a cross-sectional view of the compaction system shown in FIG. 2 after having operated to compact a plurality of bags.

FIGS. 6 is a cross-sectional view of another example compaction system having alternative features to those shown in FIGS. 1-5.

FIG. 7 is a perspective view of an inlet portion of the compaction system shown in FIGS. 1-6.

FIG. 8 is a perspective view of a compaction portion of the compaction system shown in FIGS. 1-6.

It is to be understood that specially-orienting terms, such as top, bottom, front, back, upwardly, or downwardly are used to explain relative orientation of structures as shown in the figures and as the structure might be used. They are not to be constructed, however, to require such an orientation in space.

Throughout the drawings, identical reference characters and descriptions indicate similar, but not necessarily identical, elements. While the embodiments described herein are susceptible to various modifications and alternative forms, specific embodiments have been shown by way of example in the drawings and will be described herein. However, one of ordinary skill in the art will understand that the embodiment described herein are not intended to be limited to the particular forms disclosed. Rather, the instant disclosure covers all modifications, equivalents, and alternatives falling within the scope of the appended claims.

### DETAILED DESCRIPTION

The present disclosure is generally directed to compaction devices. More particularly, the present disclosure is directed to trash compaction devices, and especially trash compaction devices that account for liquids that may be present in the trash. One aspect of the present disclosure relates to a trash compaction system that includes features that puncture the trash bags so as to permit drainage of liquids from the trash bags as part of compacting the trash. Another aspect of the present disclosure relates to liquid collection features as part of a compaction system. The liquid collection features may collect liquids that are present in the trash and properly store the liquids such as by pumping the liquids into a storage container. The liquid collection features may include a collection trough position along a bottom side of a compaction cavity of the compaction system. The compaction cavity may include a bottom surface or channel that is sloped from one end to another of the compaction cavity so that the liquids flow by gravity to the collection trough.

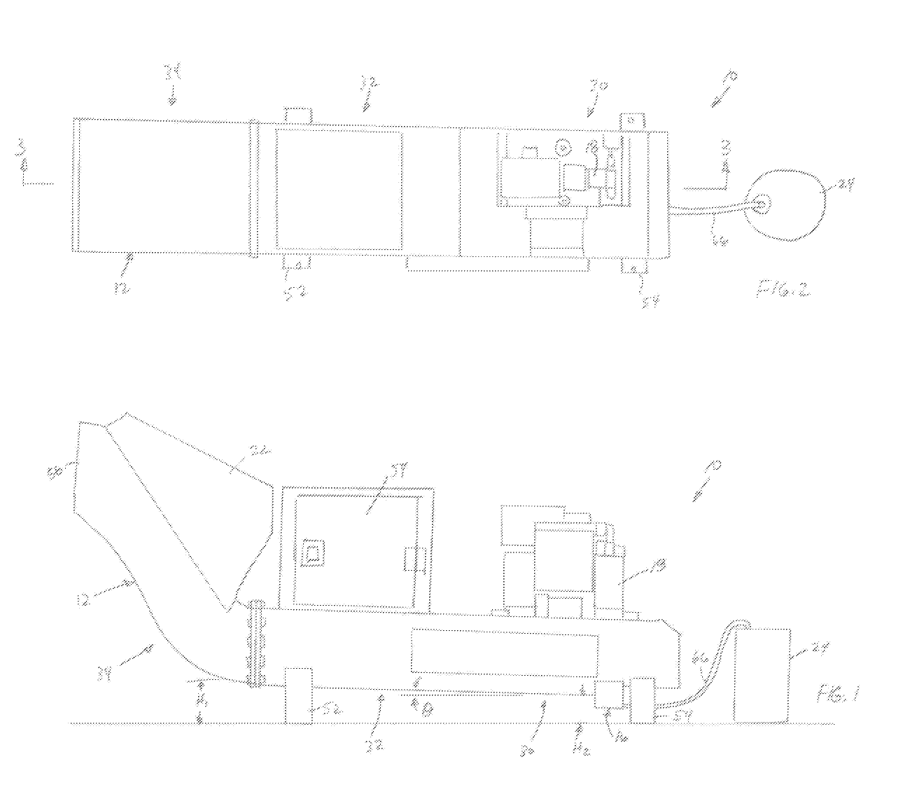

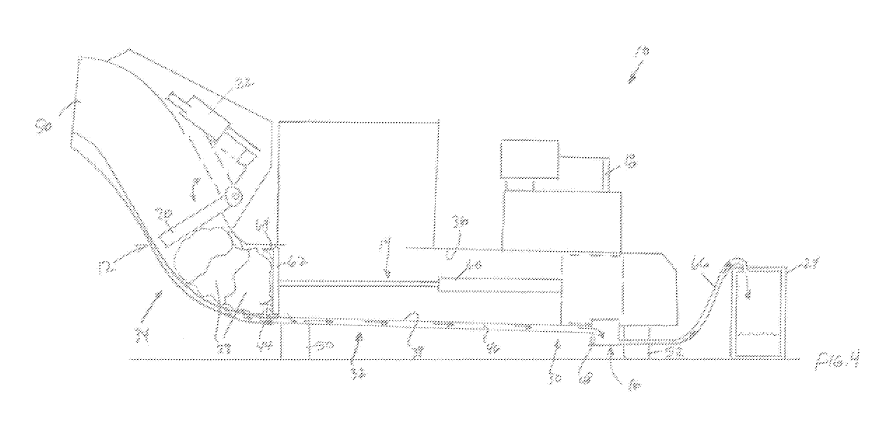

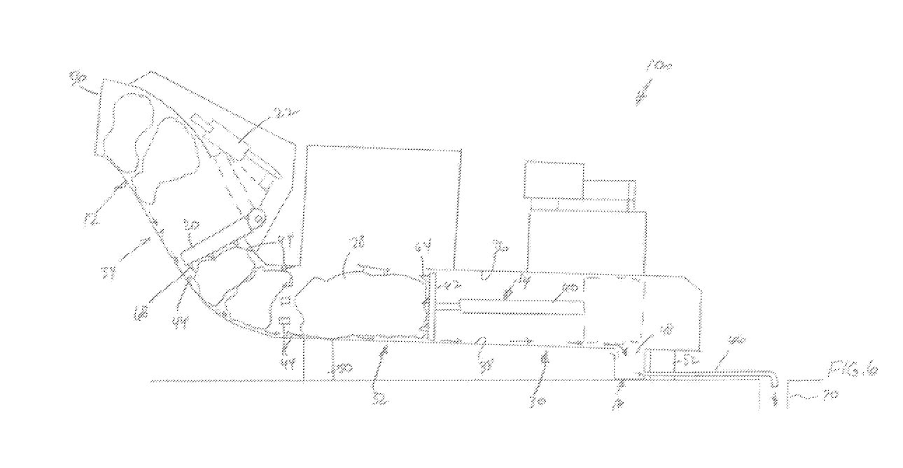

Referring now to the figures, a compaction system 10 is shown and described with reference to at least FIGS. 1-5. The compaction system 10 includes a compaction cavity 12, a compaction ram 14 (see FIG. 3), a liquid collection member 16, a ram power source 18, a movable cavity stop 20 (see FIG. 3), and a cavity stop power source 22. The compaction system 10 may also include a liquid container 24 that is connected to in flow communication with the liquid collection member 16 via hose 66. Compaction system 10 may also including a solids container 26 (see FIG. 5) that collects compacted trash.

The compaction cavity 12 may include several sections or portions along its length. For example, compaction cavity 12 may include a ram portion 30, an inlet portion 32, and a compaction portion 34. The ram portion 30 is sized to accommodate the compaction ram 14 (see FIG. 3). The inlet portion 32 is associated with an inlet door 54 that is sized to receive trash such as a bag 28 filled with liquid and solid trash (see FIG. 3). The compaction portion 34 may accommodate the movable cavity stop 20 (see FIG. 3). The trash is compacted between the movable cavity stop 20 and the compaction ram 14. The movable cavity stop 20 may rotate out of the compaction cavity 12 to permit the compacted trash to advance out of the compaction cavity through an outlet 56 (e.g., and be collected within solids container 26 shown in FIG. 5).

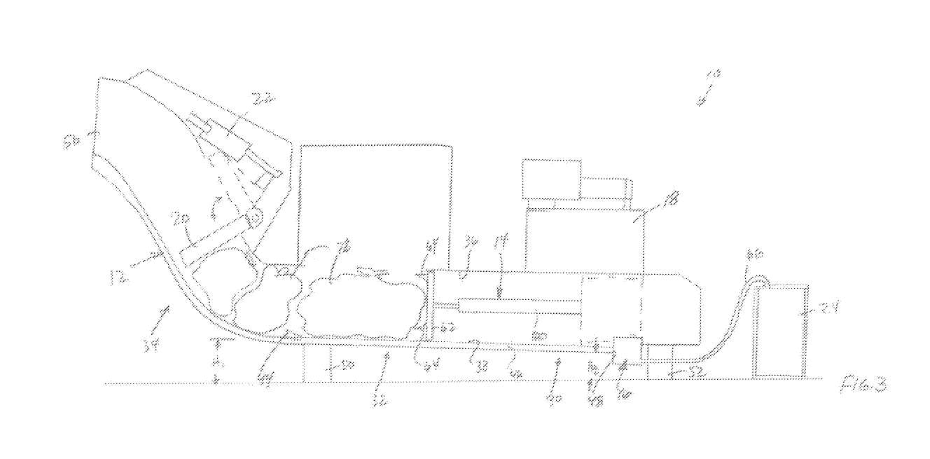

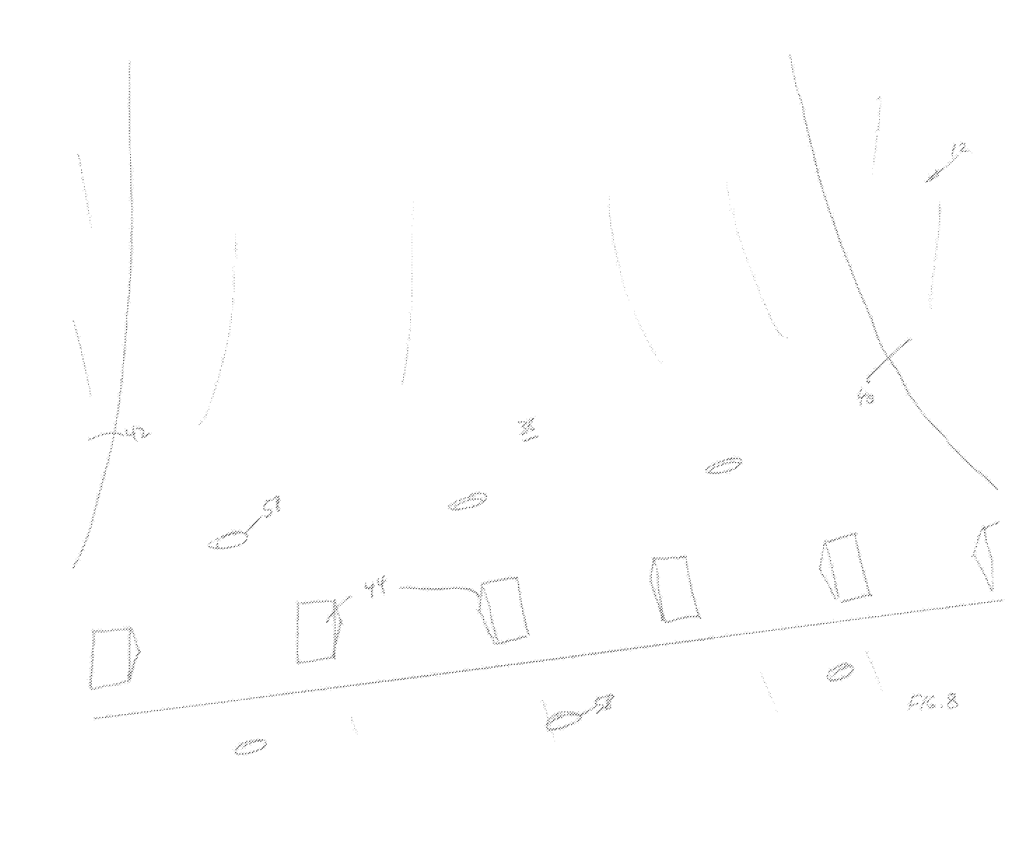

Referring to FIGS. 3-5, the compaction cavity 12 may include top and bottom walls 36, 38 and first and second sidewalls 40, 42 (see FIG. 7). The bottom wall 38 may be arranged at a sloping angle θ relative to a horizontal plane that directs liquids toward the liquid collection number 16 (see FIG. 2). The angle θ is typically in the range of about 2° to about 20°. The liquids may flow by gravity due to the sloping arrangement of the bottom wall 38. The compaction cavity 12 may be relatively liquid-tight along the bottom wall 38 and the interface between the bottom wall 38 and the sidewalls 40, 42. The compaction cavity 12 may act as a liquid channel that directs the liquids to the liquid collection member 16, which is positioned at least partially below the compaction cavity 12. The bottom wall 38 may terminate at the liquid collection member 16 such that all liquids collected within the compaction cavity 12 flow directly into the liquid collection number 16.

In some embodiments, the sloped orientation of the bottom wall 38 may be provided using a pair of support stands 50, 52 that have different heights. For example, in the compaction system 10 shown in FIGS. 1-5, the support stand 50 provides a greater height H₁ at the compaction portion 34 then a height H₂ provided by the support stand 52 at the ram portion 30. Other embodiments may provide the sloped orientation of the bottom wall 38 using other features such as, for example, the compaction cavity 12 having an enlarged cross-sectional area at the ram portion 30 as compared to the compaction portion 34.

In some embodiments, the compaction system 10 may include a liquid channel 46 formed at least in part by the bottom wall 38 (see FIG. 3). The liquid channel 46 may extend along substantially an entire length of the compaction cavity 12. The bottom wall 38 may include a plurality of perforations 58 (see FIG. 8) for the liquid to flow through and into the liquid channel 46. The liquid channel 46 may terminate at the liquid collection member 16. In some embodiments, the liquid channel 46 may extend along only a portion of the length of the compaction cavity 12 such as, for example, within the inlet portion 32 and compaction portion 34. The liquid channel 46 may have a sloping orientation that provides gravity flow of the liquid collected therein toward the liquid collection member 16. The liquid channel 46 may have a sloping orientation while the bottom wall 38 may have a generally horizontal, non-sloping orientation.

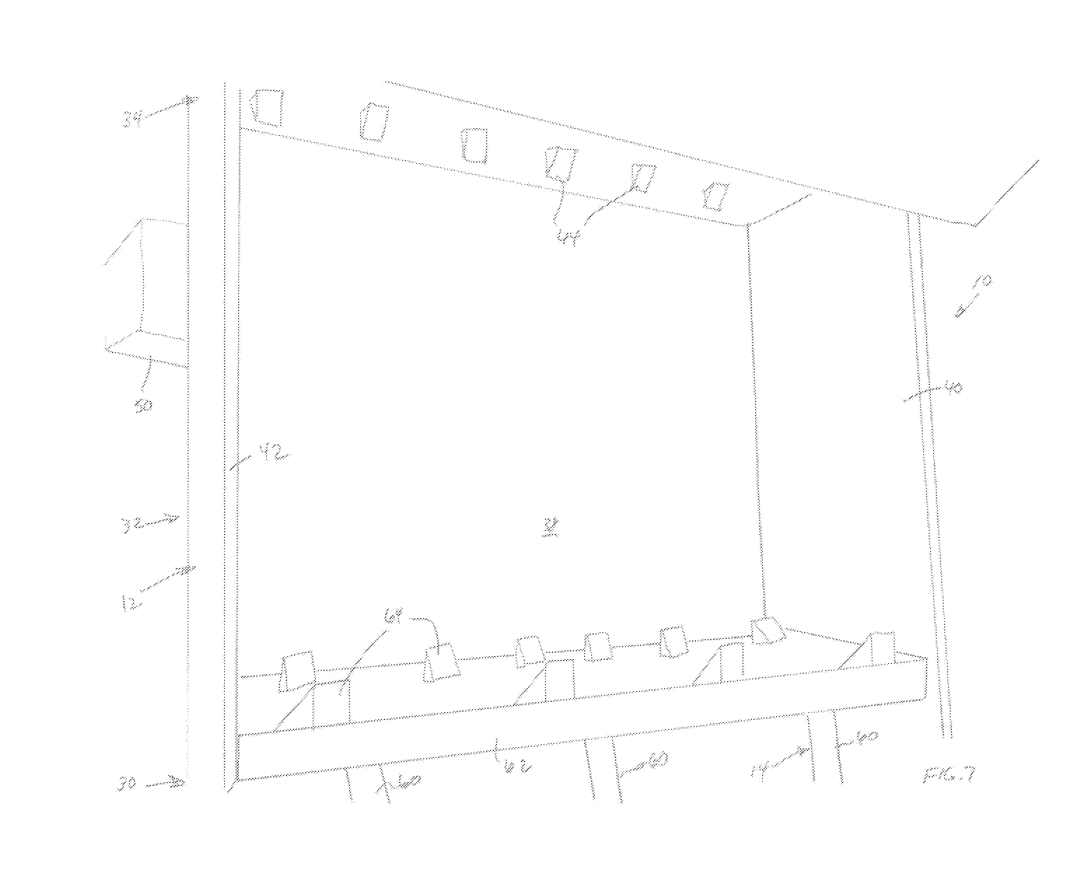

FIG. 6 illustrates a compaction system embodiment 100 that uses the bottom wall 38 to direct the liquids into a liquid collection member 16 that is supported on a ground surface beneath the compaction cavity 12. A liquid collection member 16 may be mounted to the bottom wall 38 and be elevated above the supporting ground surface. Alternatively, as shown in FIG. 6, the liquid collection member 16 may be supported on the ground surface and arranged to collect liquids that flow along the bottom wall 38 and out through an opening 48 that is formed in the bottom wall 38. The liquid collection member 16 may be drained into a sewer drain 70 or other receptacle rather than into a portable liquid container 24. In one embodiment, a liquid container 24 may be buried in the ground and the hose 66 may direct liquids from the liquid collection member 16 into the buried liquid container 24. The contents collected in the buried liquid container 24 may be removed periodically (e.g., pumped out from the buried liquid container 24). In still further embodiments, the contents collected in liquid collection member 16 may be directed into a mobile liquid container such as a container carried by a vehicle.

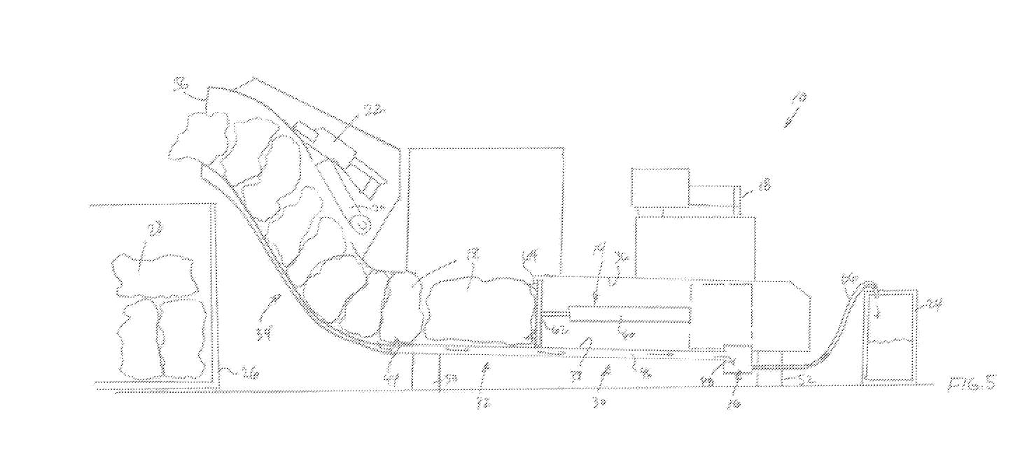

The compaction ram 14 shown in FIGS. 3-6 may include a ram member 60 and a face plate 62. The ram power source 18 provides power for operating ram member 60 between retracted and extended positions. The compaction ram 14 may include a plurality of ram members 60. The face plate 62 may include a compaction surface that faces the trash loaded into inlet portion 32. At least FIG. 3 shows a plurality of bags 28 filled with trash that are positioned in the inlet portion 32 and compaction portion 34. Operating the compaction ram 14 moves the face plate 62 along the length of the compaction cavity 12 to compact the bags 28 of trash against the movable cavity stop 20. FIG. 4 shows the compaction ram 14 fully extended to compact the bags 28. FIG. 5 shows the compaction ram 14 retracted with additional bags 28 positioned in the inlet portion 32 and compaction portion 34. Further advancing the face plate 62 from the orientation shown in FIG. 5 moves the compacted bags 28 out of the outlet 56 and into the solids container 26.

The compaction system 10 may reduce the size of the trash significantly as compared to the volume of the bags 28 before compaction. In at least some examples, compaction system 10 may reduce the volume of the trash by at least 50%, and more particularly in the range of at least 50% to 75%. The decreased volume of the bags 28 of trash permit storage of significantly more bags 28 within the solids container 26, which may improve efficiency when transporting the bags 28 to a trash storage facility.

The compaction system 10 may facilitate improved drainage of liquids from the bags 28 prior to and/or during compaction using one or more piercing members arranged to perforate and/or tear open the bags 28. The piercing members may be positioned at any number of locations in the compaction system. For example, the compaction cavity 12 may include a plurality of first piercing members 44 positioned along the bottom wall 38. The compaction ram 14 may include a plurality of second piercing member 64 positioned on the face plate 62. As the compaction ram 14 operates to contact and compact the bags 28, the second piercing member 64 may pierce the bags 28. As the compaction ram 14 moves the bags 28 into the compaction portion 34 of the compaction cavity 12, the first piercing members 44 may further puncture and/or tear open the bags 28. Punctures along a bottom portion of the bags 28 may be particularly useful for helping to drain the liquids out of the bags 28 because the liquids typically collect along the bottom end of the bag 28. The punctures formed in the bags 28 allow the liquids to flow out of the bags 28 and onto the bottom wall 38 and/or into the liquid channel 46. The sloped orientation of the bottom wall 38 and/or liquid channel 46 directs the liquids toward the liquid collection member 16. The liquids collected in liquid collection number 16 may be removed into other storage areas such as liquid container 24 (e.g., via hose 66).

Referring to FIG. 6, alternative arrangements for the piercing members are shown with respect to the compaction cavity 12, compaction ram 14, and movable cavity stop 20. FIG. 6 shows a plurality of first piercing members 44 positioned along the bottom wall 38, top wall 36 and at least one of sidewalls 40, 42. The first piercing members 44 may be positioned on any combination of the walls 36, 38, 40, 42 and at any location along the length of the compaction cavity 12 (e.g., at various locations along the length of the inlet portion 32 and/or compaction portion 34). The second piercing number 64 may be positioned at other locations along the face plate 62. One or more third piercing members 68 may be positioned on a surface of the movable cavity stop 20 that contacts the bags 28, such as during compaction of the bags 28.

FIGS. 7 and 8 are perspective views showing portions of the compaction cavity 12. FIG. 7 is a view through the inlet door 54 when the inlet door 54 is open for placement of bags 28 within the inlet portion 32. FIG. 7 shows a plurality of first piercing members 44 positioned along the bottom wall 38 at an entrance to the compaction portion 34 of compaction cavity 12. The first piercing members 44 have a ramp construction that slopes upward toward the compaction portion 34. The second piercing member 64 are shown positioned along the face plate 62 such as in rows near a bottom edge and near a top edge of the face plate 62.

The piercing members 44, 64, 68 disclosed herein may have any desired shape, size, and relative orientation to features of the compaction cavity 12, compaction ram 14, and movable cavity stop 20. In at least some arrangements, the piercing members are permanently mounted to their respective support surface, such as being welded to their respective support surface. In other embodiments, the piercing members are removable mounted, such as with a threaded fastener. The piercing members may be replaceable if damaged.

In some embodiments, different types of piercing members may be used for different types of trash being compacted in the compaction system 100. In at least some embodiments, a separate face plate 62 may be used for different types of trash, wherein each face plate includes a different arrangement and/or different sizes or shapes of piercing members.

An example method of operating compaction system 10 to compact trash, includes positioning liquid and solid trash in the inlet portion 32 of the compaction cavity 12. The trash may be held in one or more bags 28, boxes, or other containers, such as containers that are liquid-tight. The compaction ram 14 operates to move the trash from the inlet portion 32 into the compaction portion 34. At least one of the compaction cavity 12 and compaction ram 14 include at least one piercing member. The piercing member may pierce the bag 28 to facilitate draining of the liquid into the compaction cavity 12, such as onto the bottom wall 38 of the compaction cavity 12. As the compaction ram 14 compacts the bag 28 of trash, the liquids may drain out of the bag 28, move along the bottom wall 38 and/or through the liquid channel 46 positioned along and/or underneath the bottom wall 38, and collect within a liquid collection member 16 positioned underneath the bottom wall 38.

The liquid collection number 16 may be positioned at any desired location along the length of the compaction cavity 12. In the illustrated examples, the liquid collection number 16 is positioned at an end of the compaction cavity 12 that is opposite an outlet 56 where the compacted trash is ejected from the compaction system 10. The compaction ram 14 may be retracted and another bag 28 of trash may be positioned in the inlet portion 32. The compaction ram 14 may operate to compact the new bag 28. The bags 28 of trash may be pressed against the movable cavity stop 20 that is at least temporarily positioned within the compaction cavity 12 within the compaction portion 34. The movable cavity stop 20 may be movable out of the compaction cavity 12 to permit advancing of the compacted trash out of the outlet 56.

The liquids that are collected in the liquid collection member 16 may be moved into a different liquid container 24. The liquid container 24 may provide easier handling and transport of the collective liquids. The liquid container 24 may be a sealable drum or barrel. The compaction system may include a liquid pump that moves the liquids from the liquid collection member 16 into the liquid container 24. In some embodiments, the pump may operate automatically once a certain volume of liquid is collected in the liquid collection number 16. The compaction system 10 may include sensors that detect when at least one of the liquid collection number 16 and liquid container 24 are filled to a certain level. The sensors may generate signals that are used to activate an indicator or prompt generation of an alarm so that operators of the compaction system can adjust operation of the compaction system 10 to avoid spilling of the liquids.

As used throughout the specification and claims, the words “including” and “having,” as used in the specification, including the claims, have the same meaning as the word “comprising.”

The preceding description has been presented only to illustrate and describe certain aspects, embodiments, and examples of the principles claimed below. It is not intended to be exhaustive or to limit the described principles to any precise form disclosed. Many modifications and variations are possible in light of the above disclosure. Such modifications are contemplated by the inventor and within the scope of the claims. The scope of the principles described is defined by the following claims.

What is claimed is:

1. A compaction system, comprising:
a compaction cavity having an inlet opening sized to receive a bag containing liquids and solids;
a compaction ram movable within the compaction cavity to compact the bag;
wherein at least one of the compaction cavity and the compaction ram include at least one piercing member arranged and configured to puncture the bag to permit release of the liquids from the bag.

2. The compaction system of claim 1, further comprising a liquid collection member arranged to collect the liquids that are released from the bag.

3. The compaction system of claim 2, wherein the liquid collection member includes a collection pan positioned below the compaction cavity.

4. The compaction system of claim 2, wherein the compaction cavity includes a bottom wall upon which the liquids collect, the bottom wall being slanted toward the liquid collection member to provide gravity flow of the liquids.

5. The compaction system of claim 1, wherein the compaction ram includes a face plate arranged to contact the bag, and the at least one piercing member is positioned on the face plate.

6. The compaction system of claim 1, wherein the at least one piercing member includes at least one first piercing member positioned on a wall of the compaction cavity, and at least one second piercing member positioned on the compaction ram.

7. The compaction system of claim 1, wherein the at least one piercing member includes a plurality of piercing members.

8. The compaction system of claim 2, further comprising a liquid collection channel positioned along a bottom side of the compaction cavity and terminating at the liquid collection member.

9. A compaction system, comprising:
a compaction cavity comprising:
a plurality of walls including a bottom wall;
an inlet opening sized to receive a bag containing liquids and solids;
an outlet opening providing an outlet for compacted bags;
at least one first piercing member positioned on at least one of the plurality of walls;
a compaction ram movable within the compaction cavity to compact the bag, the compaction ram including a face plate arranged to contact the bag, the face plate including at least one second piercing member;
a liquid collection member positioned along a bottom side of the compaction cavity;
wherein at least one of the at least one first piercing member and the at least one second piercing member are configured to pierce the bag to permit release of the liquids from the bag onto the bottom wall, the liquids collecting in the liquid collection member.

10. The compaction system of claim 9, wherein the liquid collection member includes a collection pan that is arranged in parallel with the bottom side of the compaction cavity.

11. The compaction system of claim 9, wherein the compaction cavity includes a plurality of first piercing members positioned on the bottom wall.

12. The compaction system of claim 9, wherein the compaction ram includes a plurality of second piercing members positioned on the face plate.

13. The compaction system of claim 9, wherein the compaction cavity includes a contoured portion.

14. The compaction system of claim 9, further comprising a pump operable to remove liquids collected in the liquid collection member.

15. A method of collecting liquids from bagged refuse, the method comprising:
providing a compaction system comprising a compaction cavity, a compaction ram, a liquid collection member, and a plurality of bag piercing members positioned in the compaction cavity and positioned on the compaction ram, the compaction cavity having an inlet opening and an outlet opening;
receiving at least one bag through in the inlet opening into the compaction cavity, the at least one bag containing liquids and solids;
moving the compaction ram within the compaction cavity to compact the at least one bag;
puncturing the at least one bag with the plurality of bag piercing members to release the liquids from the bag;
collecting the liquids with a liquid collection member.

16. The method of claim 15, wherein the compaction cavity and the compaction ram each include at least one of the plurality of bag piercing members, and moving the compaction ram to compact the at least one bag causes the plurality of bag piercing members to puncture the at least one bag.

17. The method of claim 15, further comprising advancing the at least one bag out of the outlet opening after being compacted and punctured.

18. The method of claim 15, wherein the compaction cavity includes top, bottom and opposing side surfaces, and at least some of the plurality of bag piercing members are positioned on the bottom surface.

19. The method of claim 15, further comprising collecting the liquid along a bottom side of the compaction cavity.

20. The method of claim 15, further comprising orienting the compaction cavity at an angle relative to a horizontal plane and flowing the liquids along a bottom surface of the compaction cavity by gravity forces.
